(19) United States
(12) Patent Application Publication
(10) Pub. No.: US 2003/0134070 A1
(43) Pub. Date: Jul. 17, 2003

(54) Wrapping system

(76) Inventor: Allen J. Klein, Greenacres, FL (US)

Correspondence Address: PETER LOFFLER, P.O. BOX 1001, NICEVILLE, FL, 32588-1001, US

(21) Appl. No.: 09/540,941

(22) Filed: Mar. 31, 2000

(51) Int. Cl. B32B 9/00

(52) U.S. Cl. 428/40.1

(57) ABSTRACT

A wrapping system for wrapping items is comprised of a sheet member, made from paper, cloth, cellophane, foil, polymer film or similar material, having an upper surface with any desired decorative feature thereon and a lower surface that has a mid-term removable adhesive, such as an acrylic copolymer adhesive thereon. The adhesive permits an appropriate peel strength to hold around the corner of a box, yet has sufficient removability time to permit wrapping material repositioning or removal for a desired length of time after initial application.

### BACKGROUND OF THE INVENTION

1. Field of the Invention

The present invention relates to a wrapping system for wrapping desired items, the wrapping system having an adhesive thereon.

2. Background of the Prior Art

Wrapping gifts for special occasions such as Christmas, birthdays, weddings, showers, anniversaries, etc., is a long-standing tradition. Typically, the wrapping material is sized and partially wrapped around the gift and taped into place. Thereafter, another part of the gift is wrapped by the wrapping material and taped into place. This process continues until the gift is completely and properly wrapped. However, this standard scissors and tape method is not without fault. The tape can be hard to handle and can wind up as a spaghetti mess around the wrapper's fingers instead of holding the wrapping material in place. Furthermore, in maneuvering the tape into place, the need to hold the tape with one hand can make it difficult to properly hold the wrapping material in place in the other hand. The result is that the wrapping material is somewhat loose upon the gift detracting from the overall aesthetics of the wrapped gift. With many gifts, especially awkwardly shaped ones, the tape itself can be an unwanted sight. Another problem is encountered during busy present wrapping times, such as at Christmas, when the tape supply can become exhausted before all presents are wrapped.

In order to overcome the above problems, adhesive-coated wrapping paper was created. However, the problems with such paper currently found in the art is that the adhesive coating found on the paper has either a high peel strength and thus has a removability time of only about one to three seconds (similar to a self-adhesive U.S. postage stamp). In using such an adhesive-coated paper, once the adhesive is exposed, the paper must be positioned correctly almost immediately as it cannot be removed once the removability time has expired.

In order to allow repositioning of the paper after initial application, the peel strength of the adhesive is reduced in order to increase the removability time. The problem with using such adhesives is that they lack the peel strength to hold in many applications such as around the corners of boxes. While the peel strength may be generally high enough to hold the paper in place at application time, the peel strength is not high enough to properly hold the paper in place if the wrapped package is moved around to any degree. In such applications, it is not uncommon to see corners lift up out of place. In order to solve this problem, reposition adhesive-coated paper has been developed. The adhesive used with such a system allows repositioning of the paper for a few seconds up to a couple of minutes after adhesive exposure. After expiration of repositioning of the adhesive-coated paper has occurred, the peel strength of the adhesive steadily increases and can approach a peel strength of 10 pli or more. The problem with such a system occurs when a person unwraps a present. The high peel strength of the adhesive does not permit orderly unwrapping of the gift and requires ripping of the wrapping paper proper with some of the paper remaining stuck to the gift. As many individuals consider this an unsightly and undesirable feature, such a system has drawbacks.

Therefore, there is a need in the art for a gift wrapping system that overcomes the problems associated current adhesive-coated wrapping paper. Such a system must have sufficient peel strength to hold the wrapping paper in place even if the wrapped package is subject to substantial handling and movement, yet must allow a user time to reposition the paper after initial application. The system must not increase the peel strength of the adhesive to such an extent as to make the unwrapping process difficult and the system allows the wrapping paper to be removed cleanly from the gift for a desirable length of time after initial wrapping. Such a system must be relatively easy to use and must not produce a wrapping job that is unsightly.

### SUMMARY OF THE INVENTION

The wrapping system of the present invention addresses the aforementioned needs in the art. The wrapping system provides a wrapping material with an adhesive coating that has substantial peel strength to hold the paper in place even if the wrapped package undergoes substantial movement and handling. Once the wrapping material is in place, the material can be moved with respect to the package being wrapped for a sufficient amount of time. The peel strength of the adhesive remains relatively removable for a substantial length of time so that a person unwrapping a present wrapped by the system will not need to tear the wrapping material if such tearing or ripping is not desired. The length of such removability is at least 30 days so that a gift giver may wrap a present in substantial advance of the gift's unwrapping (e.g., a giver may buy and wrap a gift at Thanksgiving for delivery and unwrapping at Christmas). The wrapping system is relatively straightforward to use.

The wrapping system is comprised of a sheet member, made from any appropriate wrapping material, having an upper surface and a lower surface. The upper surface can be decorated in any desired fashion known in the art. A mid-term removable adhesive, which may be an acrylic copolymer adhesive such as the one manufactured by Franklin International of Columbus, Ohio and sold under the brand-name Covinax 252.00, is disposed on the lower surface either completely covering the lower surface or disposed in a desired pattern. By using an mid-term removable adhesive, the removability time is substantially increased—to 30 days or more—and allows a higher peel strength—between about 0.5 pli to about 2.5 pli—which is higher than is currently found on removable adhesive-coated papers such as Post-Its™, that allow repeated repositioning of the paper after its initial application yet lower than repositionable adhesives with their relatively high peel strengths and the attendant undesirable properties. A protective peel strip can be used to cover the adhesive or the upper surface may have nonstick properties.

### BRIEF DESCRIPTION OF THE DRAWINGS

FIG. 1 is an isometric view of the wrapping system of the present invention being utilized on a gift.

FIG. 2 illustrates the striped pattern of the adhesive.

FIG. 3 illustrates the crisscross pattern of the adhesive.

FIG. 4 illustrates the checkered pattern of the adhesive.

FIG. 5 illustrates the adhesive covering the entire lower surface.

FIG. 6 illustrates the scallop pattern of the adhesive.

FIG. 7 illustrates the reverse scallop pattern of the adhesive.

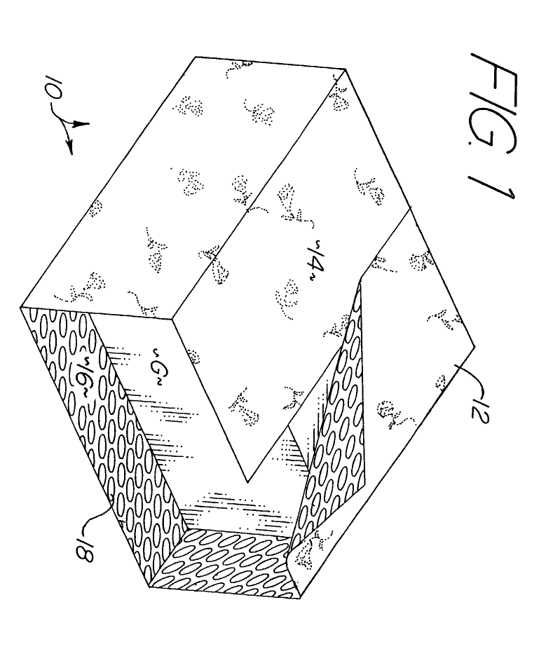

Similar reference numerals refer to similar parts throughout the several views of the drawings.

### DESCRIPTION OF THE PREFERRED EMBODIMENT

Referring now to the drawings, it is seen that the wrapping system of the present invention, generally denoted by reference numeral 10, is comprised of a relatively thin sheet member 12. The sheet member 12, which has an upper surface 14 and a lower surface 16, is made from any material that is appropriate for gift wrapping including but not limited to: paper, cloth, cellophane, foil, polymer film or any combination thereof. The upper surface 14 can be decorated in any desired fashion.

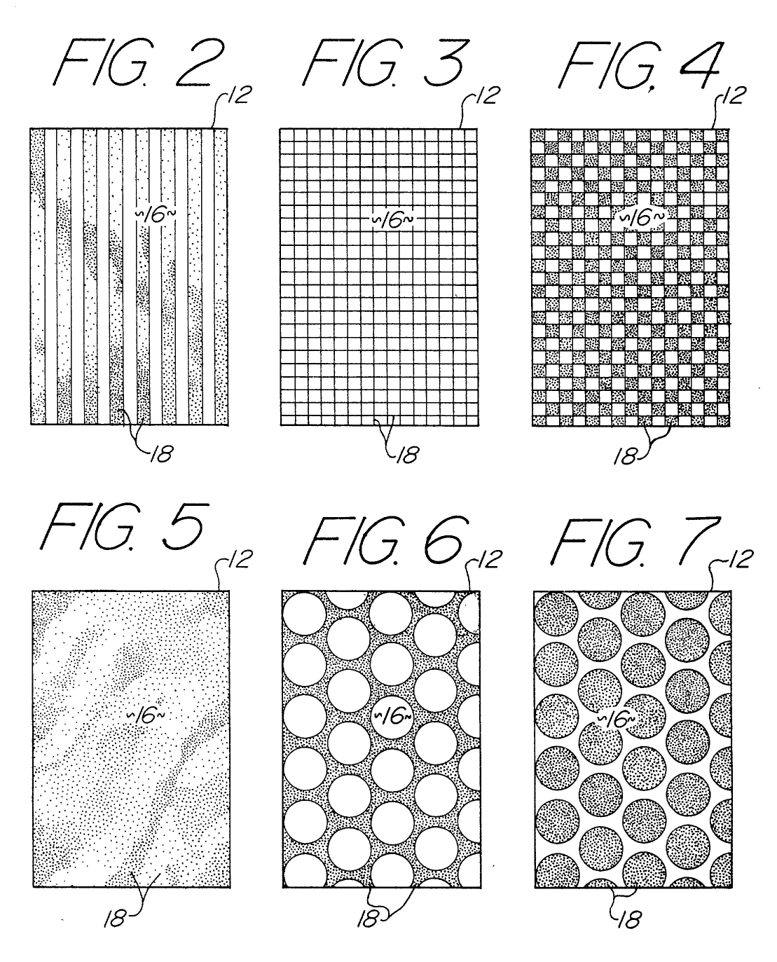

A mid-term removable adhesive 18, which may be an acrylic copolymer or equivalent, is disposed on the lower surface 16. The adhesive 18 can completely cover the lower surface 16 (FIG. 5) or can be patterned thereon in a stripe pattern (FIG. 2), a crisscross pattern (FIG. 3), a checkered pattern (FIG. 4), a scallop pattern (FIG. 6), a reverse pattern (FIG. 7), or any other desired pattern. It has been found that the use of a pattern of some fashion helps in the wrapping and unwrapping process in some applications.

The adhesive 18 will have a peel strength, measured in pounds per linear inch (phi), between about 0.5 pli and about 2.5 phi or any peel strength therebetween. The optimal peel strength has been found to be about 1.4 phi, however, this optimal peel strength can vary depending upon such factors as temperature, humidity, etc. A peel strength much below 0.5 pli will prove too weak to hold around a corner of a box or will hold but will give if the wrapped package is moved about or handled extensively after the initial wrapping. A peel strength much above 2.5 pli will prove too strong and will be too hard to work with and will also be relatively less enjoyable to remove by the gift recipient and can cause damage to the packaging of the gift. As the adhesive used is a mid-term removable adhesive, the removability time of the adhesive bond is greatly increased—typically to thirty days or longer—without the need to lower the peel strength. Therefore, the sheet material 12 can be repositioned after its initial application onto the package G being wrapped.

A peel strip of any appropriate design and construction known in the art can be used to cover the adhesive 18. Alternately, the upper surface 14 can have nonstick properties, similar to the business side of the peel strip, and the sheet member 12 can be manufactured as a roll. In a roll, the adhesive 18 would be in contact with the nonstick upper surface 14 thus dispensing with the need for the peel strip.

In order to utilize the wrapping system 10 of the present invention, the sheet material 12 is sized for the gift G to be wrapped in appropriate manner. The peel strip (if used) is removed and the gift G is positioned onto the sized sheet member 12. As each portion of the sheet member 12 is positioned into place, the adhesive 18 contacts the appropriate surface and sticks thereto. This process is continued until the entire gift G is wrapped.

While the invention has been particularly shown and described with reference to an embodiment thereof, it will be appreciated by those skilled in the art that various changes in form and detail may be made without departing from the spirit and scope of the invention.

I claim

1. A wrapping system comprising:
a sheet member having an upper surface and a lower surface; and
a mid-term removable adhesive disposed on the lower surface.

2. The wrapping system as in claim 1 wherein the adhesive is an acrylic copolymer.

3. The wrapping system as in claim 1 further comprising a peel strip covering the adhesive.

4. The wrapping system as in claim 1 further comprising a nonstick material disposed on the upper surface.

5. The wrapping system as in claim 1 wherein the sheet member is made from a material chosen from the group consisting of paper, cloth, cellophane, foil, polymer film or combinations thereof.

6. The wrapping system as in claim 1 wherein the adhesive has a peel strength of at least about 0.5 pli.

7. The wrapping system as in claim 1 wherein the adhesive has a peel strength no greater than about 2.5 pli.

8. The wrapping system as in claim 1 wherein the adhesive has a peel strength of about 1.4 pli.

9. The wrapping system as in claim 1 wherein the adhesive has a peel strength of between about 0.5 pli and about 2.5 pli.

10. The wrapping system as in claim 1 wherein the adhesive has a striped pattern.

11. The wrapping system as in claim 1 wherein the adhesive has a crisscross pattern.

12. The wrapping system as in claim 1 wherein the adhesive has a checkered pattern.

13. The wrapping system as in claim 1 wherein the adhesive has a scallop pattern.

14. The wrapping system as in claim 1 wherein the adhesive has a reverse scallop pattern.
